(19) United States
(12) Patent Application Publication
(10) Pub. No.: US 2022/0016976 A1
(43) Pub. Date: Jan. 20, 2022

(54) Vehicle Systems for Displaying Information and Methods for Operating the Same

(71) Applicant: Toyota Motor Engineering & Manufacturing North America, Inc., Plano, TX (US)

(72) Inventors: Darin Rosekrans, South Lyon, MI (US); Derek A. Thompson, Ypsilanti, MI (US); Preston Steffey, Ypsilanti, MI (US); Sean XU, Ann Arbor, MI (US); John C. Rafferty, Dexter, MI (US); Krishna Buddharaju, Northville, MI (US)

(73) Assignee: Toyota Motor Engineering & Manufacturing North America, Inc., Plano, TX (US)

(21) Appl. No.: 16/929,494

(22) Filed: Jul. 15, 2020

(51) Int. Cl. B60K 35/00; B60R 25/30; B60R 25/40; B60R 25/34; B60L 53/16; B60R 25/24; B60R 25/32; B60R 25/10; B60R 25/31; G09G 5/10; G02B 27/01; G01K 3/00

(52) U.S. Cl. CPC B60K 35/00; G02B 2027/0118; B60R 25/403; B60R 25/34; B60L 53/16; B60R 25/24; B60R 25/32; B60R 25/10; B60R 25/31; G09G 5/10; G02B 27/0101; G01K 3/005; B60K 2370/16; G09G 2380/10; G09G 2354/00; G09G 2360/144; B60R 25/305

(57) ABSTRACT

A method for displaying information from a vehicle including determining whether an occupant is within the vehicle, determining whether the vehicle is in a disengaged mode, and in response to determining that an occupant is not within the vehicle and determining that the vehicle is in the disengaged mode, directing a display positioned on at least one window of the vehicle to increase an opacity of the display.

### TECHNICAL FIELD

The present specification generally relates to vehicle systems for displaying information methods for operating the same.

### BACKGROUND

Vehicles are utilized to transport people and goods from place to place. Conventional vehicles may include windows, through which occupants within the vehicle can view objects exterior to the vehicle. However, the interior of the vehicle may also be viewed through the windows, which may be undesirable for a variety of reasons, for example when valuables are positioned within the vehicle. In some circumstances, children or pets may be inadvertently left in parked vehicles. While parked, climate control features of the vehicle may be disengaged, and the temperature of the interior of the vehicle may increase to undesirable levels.

### SUMMARY

Accordingly, a need exists for improved vehicle communication systems. Vehicle systems according to the present disclosure include displays that may selectively obscure the interior of the vehicle, for example, when the vehicle is parked. By obscuring the interior of the vehicle when parked, valuables stored within the interior of the vehicle may not be visible from the exterior of the vehicle. In some embodiments, the displays may present information related to persons and/or pets left inside the vehicle.

In one embodiment, a method for displaying information from a vehicle including determining whether an occupant is within the vehicle, determining whether the vehicle is in a disengaged mode, and in response to determining that an occupant is not within the vehicle and determining that the vehicle is in the disengaged mode, directing a display positioned on at least one window of the vehicle to increase an opacity of the display.

In another embodiment, a method for displaying information from a vehicle includes determining whether an occupant is within the vehicle, determining whether the vehicle is in a disengaged mode, determining a temperature within the vehicle, and in response to determining that (1) the occupant is within the vehicle, (2) that the vehicle is in the disengaged mode, and (3) that the detected temperature within the vehicle exceeds a configurable threshold, directing the display to display a message to persons outside the vehicle.

In yet another embodiment, a vehicle includes an occupancy detection device, a power source, an electronic computing device, a display positioned on at least one window of the vehicle, and a vehicle controller communicatively coupled to the occupancy detection device, the power source, the electronic computing device, and the display, the vehicle controller including a processor and a non-transitory, processor-readable storage medium including a computer readable and executable instruction set, which, when executed, causes the processor to receive a signal from the occupancy detection device, determine, based at least in part on the signal from the occupancy detection device, whether an occupant is positioned within the vehicle, receive a signal from at least one of the power source the electronic computing device, determine, based at least in part on the signal from the at least one of the power source and the electronic computing device, whether the vehicle is in a disengaged mode, and in response to determining that the occupant is not positioned within the vehicle and the vehicle is in the disengaged mode, send a signal to the display to increase an opacity of the display.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a vehicle, according to one or more embodiments shown and described herein;

FIG. 2A schematically depicts a display of the vehicle of FIG. 1, according to one or more embodiments shown and described herein;

FIG. 2B schematically the display of the vehicle of FIG. 1, according to one or more embodiments shown and described herein;

FIG. 3 schematically depicts a control diagram of the vehicle of FIG. 1, according to one or more embodiments shown and described herein;

FIG. 4 schematically depicts a flowchart of an example method for operating the vehicle of FIG. 1, according to one or more embodiments shown and described herein; and

FIG. 5 schematically depicts another flowchart of an example method for operating the vehicle of FIG. 1, according to one or more embodiments shown and described herein.

### DETAILED DESCRIPTION

Embodiments described herein are generally directed vehicle systems including displays that may selectively obscure the interior of the vehicle, for example, when the vehicle is parked. By obscuring the interior of the vehicle when parked, valuables stored within the interior of the vehicle may not be visible from the exterior of the vehicle. In some embodiments, the displays may present information related to persons and/or pets left inside the vehicle. These and other embodiments will now be described with reference to the appended figures.

As referred to herein, the phrase “communicatively coupled” refers to the interconnection of components such that signals can be sent between the components, and may include, for example and without limitation, a wired connection, an optical connection, a wireless connection, or the like.

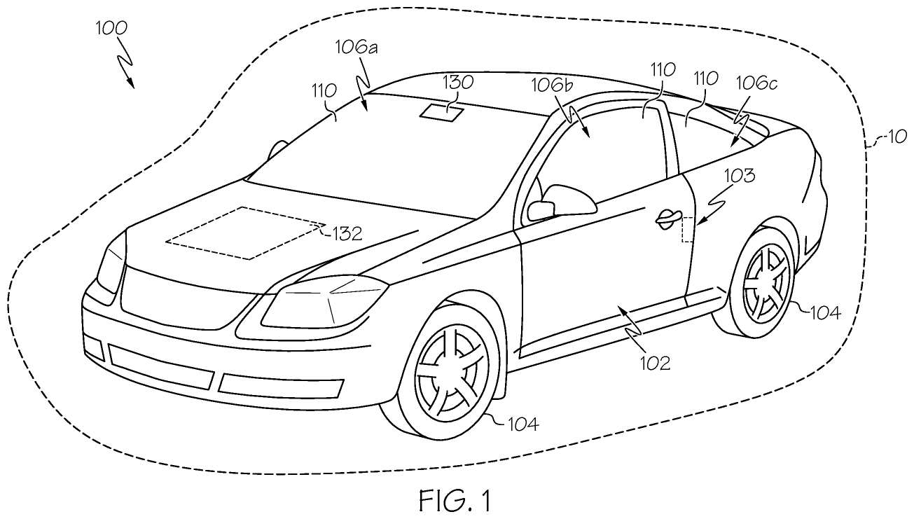

Referring initially to FIG. 1 a perspective view of a vehicle 100 is schematically depicted. In embodiments, the vehicle 100 includes one or more windows 106. For example, in the embodiment depicted in FIG. 1, the vehicle 100 includes a front windshield 106a, a front window 106b, and a rear window 106c. While in the perspective view shown in FIG. 1, the front windshield 106a, the front window 106b, and the rear window 106c are visible, it should be understood that the vehicle 100 may include additional windows on the rear and the opposite side of the vehicle 100. Further, while the embodiment depicted in FIG. 1 depicts a coupe-style vehicle including the front window 106b and the rear window 106c, it should be understood that vehicles according to the present disclosure may include any vehicle type, for example and without limitation, a sedan, a van, a pickup truck, a sport utility vehicle, a crossover vehicle, a van, a bus, or the like.

In the embodiment depicted in FIG. 1, the vehicle 100 includes one or more doors 102 that can be selectively opened and closed, for example, to permit ingress and egress from the vehicle 100. In some embodiments, the door 102 may include a lock 103 that is movable between an unlocked position, in which the door 102 is movable between an open and a closed position, and a locked position, in which the door 102 is restricted from moving between the open and the closed position. While a single door 102 is shown in the view depicted in FIG. 1, it should be understood that in embodiments described herein, the vehicle 100 may include any suitable number of doors.

In embodiments, the vehicle 100 includes a power source 132 that provides the vehicle 100 with mobility. For example, the power source 132 may rotate a crankshaft that is coupled to one or more wheels 104 of the vehicle 100. In embodiments, the power source 132 may include any suitable device for rotating the crankshaft. For example, in some embodiments, the power source 132 may include an internal combustion engine. In some embodiments, the power source 132 may include an electrical power source, for example a battery electrically coupled to an electrical motor. In some embodiments, for example in hybrid-electric vehicles, the power source 132 may include a combination of devices, for example, an internal combustion engine and a battery electrically coupled to an electrical motor.

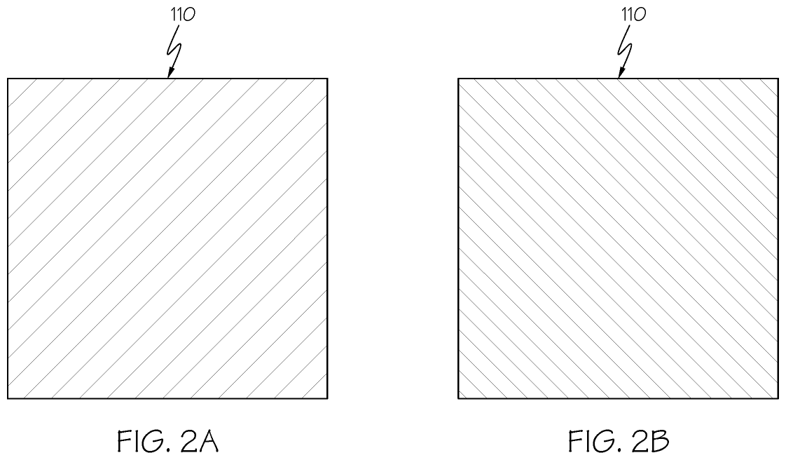

In embodiments, one or more displays 110 may be positioned on the one or more windows 106. In embodiments, the displays 110 may include light emitting diode (LED) arrays or the like that are capable of displaying textual messages and/or changing opacity. The displays 110 may permit an occupant within the vehicle 100 to see out the windows 106a, 106b, 106c, and may display textual messages that can be viewed from an exterior of the vehicle 100. Similarly, in some embodiments, the displays 110 may permit an occupant within the vehicle 100 to see out the windows 106a, 106b, 106c, and may change opacity as viewed from the exterior of the vehicle 100. For example and referring to FIGS. 2A and 2B a display 110 is shown at a relatively low opacity in FIG. 2A, and a relatively high opacity in FIG. 2B, where the opacity shown in FIG. 2B is higher than the opacity shown in FIG. 2A.

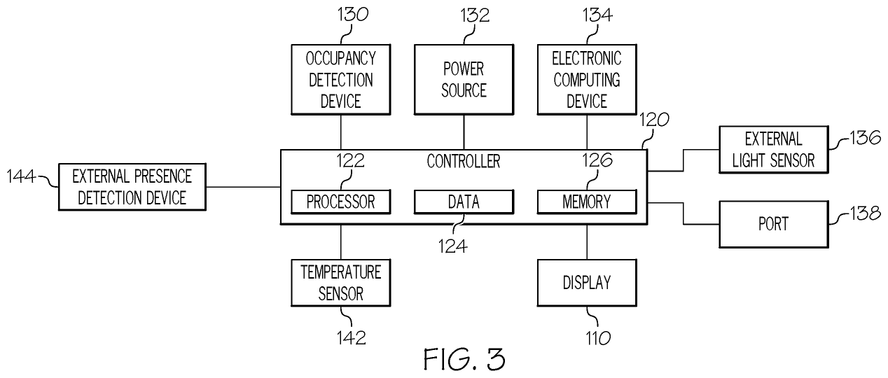

Referring to FIG. 3, a control diagram for the vehicle 100 is schematically depicted. In embodiments, the vehicle 100 includes a controller 120. As illustrated, the controller 120 includes a processor 122, a data storage component 124, and/or a memory component 126. The memory component 126 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the controller 120 and/or external to the controller 120.

The memory component 126 may store operating logic, analysis logic, and communication logic in the form of one or more computer readable and executable instruction sets. The analysis logic and the communication logic may each include a plurality of different pieces of logic, each of which may be embodied as a computer program, firmware, and/or hardware, as an example. A local interface is also included in the controller 120, and may be implemented as a bus or other communication interface to facilitate communication among the components of the controller 120.

The processor 122 may include any processing component operable to receive and execute instructions (such as from a data storage component 124 and/or the memory component 126). It should be understood that while the components in FIG. 3 are illustrated as residing within the controller 120, this is merely an example, and in some embodiments, one or more of the components may reside external to the controller 120. It should also be understood that, while the controller 120 is illustrated as a single device, this is also merely an example.

In embodiments, the controller 120 is communicatively coupled to one or more components of the vehicle 100. For example, in the embodiment depicted in FIG. 3, the controller 120 is communicatively coupled to the one or more displays 110 and the power source 132.

In some embodiments, the vehicle 100 further includes a temperature sensor 142, an external presence detection device 144, an occupancy detection device 130, an electronic computing device 134, an external light sensor 136, and/or a port 138 communicatively coupled to the controller 120.

Referring to FIGS. 1 and 3, in embodiments the external presence detection device 144 such that the controller 120 may receive and/or send signals to the external presence detection device 144. In embodiments, the external presence detection device 144 is structurally configured to detect the presence of a person or persons within a configurable distance 10 of the vehicle 100. For example, in some embodiments, the external presence detection device 144 may include one or more externally-facing cameras that send signals to the controller 120, for example, signals indicative of images of the vehicle's 100 surroundings. In these embodiments, the controller 120 may include image recognition software that is capable of identifying the presence of a person within the configurable distance 10 of the vehicle 100. In some embodiments, the external presence detection device 144 may include any suitable device or devices suitable for detecting the presence of a person or persons within the configurable distance 10 of the vehicle 100, and may include, for example and without limitation, radio detection and ranging (RADAR) devices, light detection and ranging (LIDAR) devices, one or the like. In these embodiments, the external presence detection device 144 may send signals to the controller 120 indicative of the presence of a person or persons within the configurable distance 10 of the vehicle 100.

Still referring to FIGS. 1 and 3, in some embodiments, the vehicle 100 includes the occupancy detection device 130 communicatively coupled to the controller 120, such that the controller 120 may receive and/or send signals to the occupancy detection device 130. In embodiments, the occupancy detection device 130 includes any device structurally configured to detect the presence of a person or persons and/or an animal or animals within the vehicle 100. For example, in some embodiments, the occupancy detection device 130 may include an internally-facing camera or cameras that send signals to the controller 120, for example, signals including images of the vehicle's 100 interior. The controller 120 may include image recognition software that is capable of identifying the presence of a person or persons and/or an animal or animals within the interior of the vehicle 100. In some embodiments, the occupancy detection device 130 may include any device or devices suitable for detecting the presence of a person or persons and/or an animal or animals within the vehicle 100, and may include, for example and without limitation, RADAR devices, LIDAR devices, one or the like. In these embodiments, the occupancy detection device 130 may send signals to the controller 120 indicative of the presence of a person or persons and/or an animal or animals within the vehicle 100.

In embodiments, the power source 132 is communicatively coupled to the controller 120 such that the power source 132 may send and/or receive signals from the controller 120. The controller 120 may receive signals from the power source 132, for example, signals indicative of whether the power source 132 is engaged or disengaged. In embodiments in which the power source 132 includes an internal combustion engine, the power source 132 may combust fuel while engaged. In embodiments in which the power source 132 includes a battery electrically coupled to a motor, the power source 132 may provide or be available to provide electrical current to the motor or other vehicle systems while engaged.

In embodiments, the electronic computing device 134 is communicatively coupled to the controller 120 such that the electronic computing device 134 may send and/or receive signals from the controller 120. In embodiments, the controller 120 receives signals from the electronic computing device 134 that cause the controller 120 to control one or more of the components of the vehicle 100 (e.g., the one or more displays 110, the power source 132). In embodiments, the electronic computing device 134 may include, for example and without limitation, a phone, a tablet, a phablet, an electronic key, a key fob, or the like. In embodiments, the controller 120 may receive a signal from the electronic computing device 134 indicative of an instruction to engage the power source 132, and in response, the controller 120 may send a signal to engage the power source 132. The controller 120, in embodiments, may receive a signal from the electronic computing device 134 indicative of an instruction to engage the one or more displays 110, and in response, the controller 120 may direct the one or more displays 110 engage, as described in greater detail herein.

In embodiments, the external light sensor 136 is communicatively coupled to the controller 120 such that the external light sensor 136 may send and/or receive signals from the controller 120. The external light sensor 136, in some embodiments, is structurally configured to detect a level of light external to the vehicle 100, and may include a photodetector, a photoreciever or the like. In embodiments, the controller 120 may receive a signal or signals from the external light sensor 136 indicative of a detected light level external to the vehicle 100, as described in greater detail herein.

In embodiments, the port 138 is communicatively coupled to the controller 120 such that the port 138 may send and/or receive signals from the controller 120. The port 138, in embodiments, may include a receptacle or the like structurally configured to receive an electrical charger. For example, in embodiments in which the vehicle 100 is an electric vehicle or hybrid electric vehicle, the power source 132 may be periodically connected to an electrical charger via the port 138. In particular, the port 138 may be electrically coupled to the power source 132, such that electrical current can be passed from an electrical charger, through the port 138, to the power source 132 to charge the power source 132. In embodiments, the controller 120 may receive signals from the port 138 indicative of whether an electrical charger is coupled to the port 138.

In embodiments, the temperature sensor 142 is communicatively coupled to the controller 120 such that the temperature sensor 142 may send and/or receive signals from the temperature sensor 142. For example, in embodiments, the controller 120 may receive signals from the temperature sensor 142 indicative of a detected temperature within an interior of the vehicle 100.

In embodiments, the controller 120 may direct the one or more displays 110 to engage based on signals received from any of the temperature sensor 142, the external presence detection device 144, the occupancy detection device 130, the power source 132, the electronic computing device 134, the external light sensor 136, and/or the port 138.

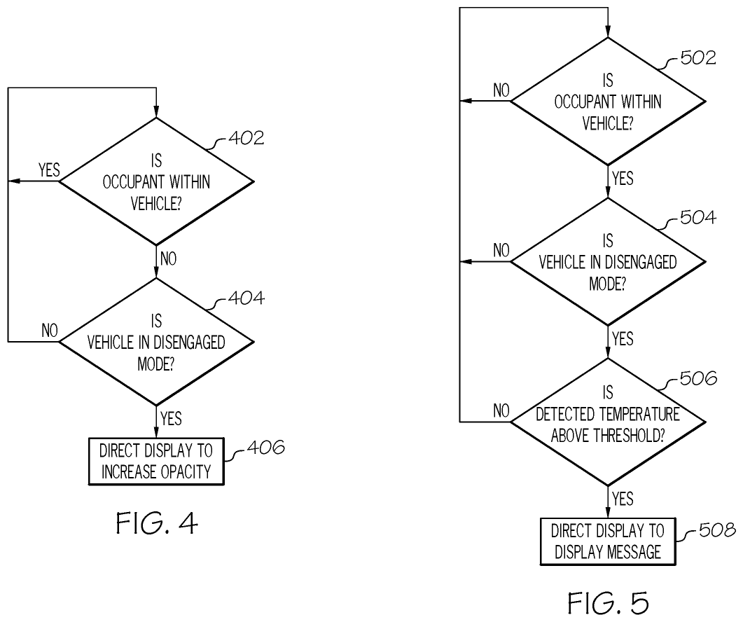

For example and referring to FIGS. 1, 3, and 4, a flowchart of an example method of operating the vehicle 100 is depicted. In some embodiments, the controller 120 may perform the method depicted in FIG. 4, and in block 402, the controller 120 determines whether an occupant (e.g., one or more persons and/or one or more animals) is within the vehicle 100. For example, in embodiments, the controller 120 receives a signal from the occupancy detection device 130 indicative of whether an occupant is in the vehicle 100. In response to determining that an occupant is within the vehicle 100, the controller 120 remains at the block 402. In response to determining that an occupant is not within the vehicle 100, the controller 120 proceeds to block 404, where the controller 120 determines whether the vehicle 100 is in a disengaged mode. In some embodiments, the controller 120 may determine whether the vehicle 100 is in the disengaged mode by receiving a signal from the power source 132 indicating whether the power source 132 is engaged or disengaged.

In some embodiments, the controller 120 may determine whether the vehicle 100 is in the disengaged mode by determining whether the lock 103 of the vehicle 100 is in a locked position. For example, in embodiments, the controller 120 may receive a signal from the electronic computing device 134 to move the lock 103 from the unlocked position to the locked position to determine that the lock 103 is in the locked position. In some embodiments, the controller 120 may be communicatively coupled to one or more sensors that can directly detect whether the lock 103 is in the locked position.

In some embodiments, the controller 120 may determine whether the vehicle 100 is in the disengaged mode by detecting whether the electronic computing device 134 is within the configurable distance 10 of the vehicle 100. For example, when a user exits the vehicle 100, the user may retain the electronic computing device 134 and may move outside of the configurable distance 10 of the vehicle 100.

In some embodiments, the controller 120 may determine whether the vehicle 100 is in the disengaged mode by determining whether an electrical charger is coupled to the port 138. For example, the controller 120 may receive a signal from the port 138 indicative of whether an electrical charger is coupled to the port 138, e.g., when the vehicle 100 is at a charging station.

At block 406, in response to determining that an occupant is not within the vehicle 100 and determining that the vehicle 100 is in the disengaged mode, the controller 120 directs the one or more displays 110 to increase an opacity of the one or more displays 110. When the vehicle 100 is in a disengaged mode and no occupants are present within the vehicle 100, for example, when the vehicle 100 is parked, it may be desirable to obscure the interior of the vehicle 100. By obscuring the interior of the vehicle 100, for example, by increasing the opacity of the one or more displays 110, objects such a valuables within the vehicle 100 may be obscured from view by persons passing by the vehicle 100.

While in the flowchart depicted in FIG. 4, blocks 402 and 404 are depicted and described as being performed in sequential order, it should be understood that this is merely an example, and blocks 402 and 404 can be performed in any order, and may be performed simultaneously.

In some embodiments, the controller 120 may further direct the one or more displays 110 to increase in opacity in response to detecting the presence of a person within the configurable distance 10 of the vehicle 100. For example, when the vehicle 100 is parked, the controller 120 may direct the one or more displays 110 to increase in opacity in response to detecting the presence of a person (e.g., a passerby) thereby further ensuring that objects within the vehicle 100 are obscured from view.

In some embodiments, the controller 120 may further determine an amount of light on the exterior of the vehicle 100. For example, the controller 120 may receive a signal from the external light sensor 136 indicative of a detected amount of light on the exterior of the vehicle 100. In some embodiments, the opacity of the one or more displays 110 is based at least in part on the determined amount of light on the exterior of the vehicle 100. For example, in some embodiments, the controller 120 may direct the one or more displays 110 to increase the opacity of the one or more displays 110 in response to determining a comparatively high amount of light on the exterior of the vehicle 100. By contrast, the controller 120 may direct the one or more displays 110 to decrease the opacity of the one or more displays 110 in response to determining a comparatively low amount of light on the exterior of the vehicle 100, where the comparatively low amount of light is less than the comparatively high amount of light. In some embodiments, the controller 120 may direct the one or more displays 110 to increase the opacity of the one or more displays 110 in response to determining that the detected amount of light exceeds a configurable threshold. By directing the one or more displays 110 to increase the opacity of the one or more displays 110 based at least in part on the detected amount of light on the exterior of the vehicle 100, light may be restricted from passing through one or more of the windows 106a, 106b, 106c. For example, on a sunny day where the amount of light on the exterior of the vehicle 100 is comparatively high, light passing through the windows 106a, 106b, 106c may increase the temperature on the interior of the vehicle 100 to undesirable temperatures. To maintain the temperature on the interior of the vehicle 100 at a desirable temperature, one or more energy-intensive cooling systems, such as air-conditioning or the like may then be employed, thereby increasing the energy consumption of the vehicle 100 and decreasing the efficiency of the vehicle 100. Further, in circumstances in which the vehicle 100 is parked in a sunny position, the cooling systems of the vehicle 100 may not be operating, and may require time to cool the interior of the vehicle 100 when the vehicle 100 is again started by a user. While the cooling system is cooling the interior of the vehicle 100 to a desirable temperature, the interior of the vehicle 100 may be at undesirable temperatures, leading to an uncomfortable experience for the occupants of the vehicle 100. By increasing the opacity of the one or more displays 110, the amount of light passing through the windows 106a, 106b, 106c may be decreased, assisting in maintaining the interior of the vehicle 100 at a desirable temperature.

In some embodiments, the opacity of the one or more displays 110 may be increased upon the engagement of an entertainment system communicatively coupled to the controller 120. In some embodiments, for example in embodiments in which the vehicle 100 is an autonomous vehicle 100, persons within the vehicle 100 may utilize the entertainment systems of the vehicle 100 when the vehicle 100 is in operation. In some circumstances, entertainment systems within the vehicle 100, such as television screens or the like, may be difficult to view in high light situations. Accordingly, by increasing the opacity of the one or more displays 110, the entertainment system of the vehicle 100 may be more easily viewed by persons within the vehicle 100.

Referring to FIGS. 1, 3, and 5, a flowchart of another example method of operating the vehicle 100 is depicted. In some embodiments, the controller 120 may perform the method depicted in FIG. 5, and in block 502, the controller 120 determines whether an occupant (e.g., one or more persons and/or one or more animals) is within the vehicle 100. For example, in embodiments, the controller 120 receives a signal from the occupancy detection device 130 indicative of whether an occupant is in the vehicle 100. In response to determining that an occupant is not within the vehicle 100, the controller 120 remains at the block 502. In response to determining that an occupant is within the vehicle 100, the controller 120 proceeds to block 504, where the controller 120 determines whether the vehicle 100 is in a disengaged mode. In some embodiments, the controller 120 may determine whether the vehicle 100 is in the disengaged mode by receiving a signal from the power source 132 indicating whether the power source 132 is engaged or disengaged.

In some embodiments, the controller 120 may determine whether the vehicle 100 is in the disengaged mode by determining whether the lock 103 of the vehicle 100 is in a locked position. For example, in embodiments, the controller 120 may receive a signal from the electronic computing device 134 to move the lock 103 from the unlocked position to the locked position to determine that the lock 103 is in the locked position. In some embodiments, the controller 120 may be communicatively coupled to one or more sensors that can directly detect whether the lock 103 is in the locked position.

In some embodiments, the controller 120 may determine whether the vehicle 100 is in the disengaged mode by detecting whether the electronic computing device 134 is within the configurable distance 10 of the vehicle 100. For example, when a user exits the vehicle 100, the user may retain the electronic computing device 134 and may move outside of the configurable distance 10 of the vehicle 100.

In some embodiments, the controller 120 may determine whether the vehicle 100 is in the disengaged mode by determining whether an electrical charger is coupled to the port 138. For example, the controller 120 may receive a signal from the port 138 indicative of whether an electrical charger is coupled to the port 138, e.g., when the vehicle 100 is at a charging station.

In response to determining that the vehicle 100 is in the disengaged mode, at block 504, the controller 120 determines whether a detected temperature within the vehicle 100 is above a configurable threshold. For example, in embodiments, the controller 120 receives a signal from the temperature sensor 142 indicative of a detected temperature within the vehicle 100.

In response to determining that an occupant is within the vehicle 100, that the vehicle 100 is in the disengaged mode, and the that detected temperature within the vehicle 100 is above the configurable threshold, at block 508, the controller 120 directs the one or more displays 110 to display a message. For example, in some embodiments, the one or more displays 110 may flicker or blink to alert passersby. In some embodiments, the one or more displays 110 may display a textual message, displaying, for example, the detected temperature within the vehicle and text directing passersby to contact the authorities. In this way, the one or more displays 110 may be utilized to alert passersby to potentially dangerous situations in which an occupant (e.g., a child or a pet animal) is left in a parked car.

In some embodiments, the controller 120 may determine an amount of time that the vehicle 100 has been in the disengaged mode, and may direct the one or more displays 110 to display a message indicative of the amount of time the vehicle 100 has been in the disengaged mode.

In some embodiments, the controller 120 and/or the displays 110 may be communicatively coupled to external networks or the like and may display information based at least in part on signals received from the external networks. For example, in some embodiments, the displays may convey a vehicle's 100 commercial status, e.g., “Available Taxi,” or “Pickup for Joe” to alert persons outside of the vehicle 100 of the status of the vehicle 100.

In some embodiments, the displays 110 may also convey information associated with the operation of the vehicle 100. For example, in some embodiments, the controller 120 may be connected to the vehicle's 100 brakes, and may indicate when the vehicle's 100 brakes are depressed.

In some embodiments, the controller 120 and/or the displays 110 may be communicatively coupled to infrastructure surrounding the vehicle 100. As one example, the controller 120 may be communicatively coupled to a parking meter associated with a space where the vehicle 100 is parked. In these embodiments, the controller 120 may direct the displays 110 to display an amount of time allotted for the vehicle 100 to be parked in the space, thereby alerting passersby to an approximate time the space will become available.

It should now be understood that embodiments described herein are directed to Embodiments described herein are generally directed vehicle systems including displays that may selectively obscure the interior of the vehicle, for example, when the vehicle is parked. By obscuring the interior of the vehicle when parked, valuables stored within the interior of the vehicle may not be visible from the exterior of the vehicle. In some embodiments, the displays may present information related to persons and/or pets left inside the vehicle.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for displaying information from a vehicle, the method comprising:
determining whether an occupant is within the vehicle;
determining whether the vehicle is in a disengaged mode; and
in response to determining that an occupant is not within the vehicle and determining that the vehicle is in the disengaged mode, directing a display positioned on at least one window of the vehicle to increase an opacity of the display.

2. The method of claim 1, wherein determining whether the vehicle is in the disengaged mode comprises determining whether a power source of the vehicle is disengaged.

3. The method of claim 2, wherein the power source is at least one of an electrical power source and an internal combustion engine.

4. The method of claim 1, wherein determining whether the vehicle is in the disengaged mode further comprises determining whether a lock of a door of the vehicle is in a locked position.

5. The method of claim 1, wherein determining whether the vehicle is in the disengaged mode comprises determining whether an electronic computing device is positioned within a configurable distance of the vehicle.

6. The method of claim 1, wherein determining whether the vehicle is in the disengaged mode comprises detecting that an electrical charger is coupled a port to the vehicle.

7. The method of claim 6, wherein electronic computing device is at least one of a phone, tablet, a phablet, an electronic key, and a key fob.

8. The method of claim 1, wherein detecting whether the occupant is within the vehicle comprises receiving an image of the occupant via a camera.

9. The method of claim 1, further comprising determining whether a person is positioned within a configurable distance of the vehicle, and in response to detecting that the person is positioned within the configurable distance of the vehicle, increasing the opacity of the display.

10. The method of claim 1, further comprising determining an amount of light on an exterior of the vehicle, and wherein the opacity of the display is based at least in part on the detected amount of light on the exterior of the vehicle.

11. A method for displaying information from a vehicle, the method comprising:
determining whether an occupant is within the vehicle;
determining whether the vehicle is in a disengaged mode;
determining a temperature within the vehicle; and
in response to determining that (1) the occupant is within the vehicle, (2) that the vehicle is in the disengaged mode, and (3) that the detected temperature within the vehicle exceeds a configurable threshold, directing a display to show a message to persons outside the vehicle.

12. The method of claim 11, further comprising directing the display to show a message indicative of the detected temperature within the vehicle.

13. The method of claim 11, further comprising determining an amount of time the vehicle has been in the disengaged mode, and directing the display to show a message indicative of the amount of time the vehicle has been in the disengaged mode.

14. A vehicle comprising:
an occupancy detection device;
a power source;
an electronic computing device;
a display positioned on at least one window of the vehicle; and
a vehicle controller communicatively coupled to the occupancy detection device, the power source, the electronic computing device, and the display, the vehicle controller comprising a processor and a non-transitory, processor-readable storage medium comprising a computer readable and executable instruction set, which, when executed, causes the processor to:
receive a signal from the occupancy detection device;
determine, based at least in part on the signal from the occupancy detection device, whether an occupant is positioned within the vehicle;
receive a signal from at least one of the power source the electronic computing device;
determine, based at least in part on the signal from the at least one of the power source and the electronic computing device, whether the vehicle is in a disengaged mode; and
in response to determining that the occupant is not positioned within the vehicle and the vehicle is in the disengaged mode, send a signal to the display to increase an opacity of the display.

15. The vehicle of claim 14, wherein the signal from the at least one of the power source and the electronic computing device is received from the electronic computing device, and wherein the computer readable and executable instruction set, when executed, further causes the processor to detect whether the electronic computing device is within a configurable distance of the vehicle to determine whether the vehicle is in the disengaged mode.

16. The vehicle of claim 15, wherein the electronic computing device is at least one of a phone, tablet, a phablet, an electronic key, and a key fob.

17. The vehicle of claim 14, further comprising an external presence detection device communicatively coupled to the vehicle controller, and wherein the computer readable and executable instruction set, when executed, further causes the processor to:
receive a signal from the external presence detection device indicative of whether a person is positioned within a configurable distance of the vehicle; and
in response to receiving a signal from the external presence detection device that the person is positioned within the configurable distance of the vehicle, direct the display to increase the opacity of the display.

18. The vehicle of claim 14, further comprising a temperature sensor communicatively coupled to the vehicle controller.

19. The vehicle of claim 18, wherein the computer readable and executable instruction set, when executed, further causes the processor to:
receive a signal from the temperature sensor indicative of a detected temperature within the vehicle;
determine whether the detected temperature exceeds a configurable threshold; and
in response to determining that (1) the occupant is within the vehicle, (2) that the vehicle is in the disengaged mode, and (3) that the detected temperature within the vehicle exceeds a configurable threshold, direct the display to show a message to persons outside the vehicle.

20. The vehicle of claim 19, wherein the computer readable and executable instruction set, when executed, further causes the processor to direct the display to show a message indicative of the detected temperature within the vehicle.
